(19) United States
(12) Patent Application Publication
(10) Pub. No.: US 2023/0391557 A1
(43) Pub. Date: Dec. 7, 2023

(54) CONVEYANCE SYSTEM

(71) Applicant: MURATA MACHINERY, LTD., Kyoto-shi, Kyoto (JP)

(72) Inventor: Takeshi OMAE, Inuyama-shi (JP)

(21) Appl. No.: 18/033,159

(22) PCT Filed: Sep. 6, 2021
(86) PCT No.: PCT/JP2021/032660

§ 371 Date: Apr. 21, 2023

(30) Foreign Application Priority Data
Nov. 17, 2020 (JP) 2020-190928

(51) Int. Cl. B65G 43/08; B65G 47/52; B65G 47/42

(52) U.S. Cl. CPC B65G 43/08; B65G 2203/0233; B65G 47/42; B65G 47/52

(57) ABSTRACT

In a conveyance system, a circular conveyor includes a circular rail to convey and deliver packages. A discharge conveyor includes a transferable section parallel or substantially parallel to a rail of the circular conveyor. A retrieval controller is configured or programmed to determine a retrieval order of the packages to be delivered from the discharge conveyor, and determine a package delivery position on the discharge conveyor based on the retrieval order.

### BACKGROUND OF THE INVENTION

### 1. Field of the Invention

The present invention relates to a conveyance system, particularly a conveyance system including a circular conveyor and a discharge conveyor.

### 2. Description of the Related Art

Conventionally, in order to transfer packages between an automated warehouse and a conveyor to be a loading and unloading unit for a truck or the like, a circular track and a plurality of conveying carts moving thereon are installed. For instance, there is known a package transfer device including a transfer conveyor disposed partially in parallel to a traveling rail (see PCT Publication No. 2018/139098). In this device, the conveying cart is moved on the traveling rail while the package is delivered to the transfer conveyor.

### SUMMARY OF THE INVENTION

Conventionally, if the order of loading packages onto the truck is predetermined, packages are retrieved in proper order from the automated warehouse (hereinafter, referred to as ordered retrieval). The ordered retrieval is used, for example, when packages for a plurality of shops are loaded in the truck, which transports the packages to the shops in order. In this case, with a conventional system, it is necessary to monitor in real time a retrieval situation of the automated warehouse and conveyance situation of sorting carts, and hence a capacity of the conveying equipment cannot be fully utilized.

Preferred embodiments of the present invention set a retrieval order properly regardless of an arrival order of packages to a conveyance system.

Hereinafter, a plurality of aspects of preferred embodiments of the present invention are described and can be arbitrarily combined as necessary.

A conveyance system according to one aspect of a preferred embodiment of the present invention includes a circular conveyor, a discharge conveyor, and a controller. The circular conveyor includes a circular package conveyance path to convey a package, and is capable of delivering the package. The discharge conveyor includes a transferable section parallel or substantially parallel to the package conveyance path of the circular conveyor, so as to enable a plurality of packages to be placed thereon. The controller is configured or programmed to determine a retrieval order in which the packages are retrieved from the discharge conveyor, and to control a package delivery position on the discharge conveyor, based on the retrieval order. In this system, the package is delivered from the circular conveyor to the discharge conveyor. As the transferable section of the discharge conveyor is parallel or substantially parallel to the circular conveyor, the circular conveyor can deliver a plurality of packages to the transferable section. Therefore, by changing a package delivery planned position for each package, the retrieval order can be set properly regardless of an arrival order of packages to the conveyance system.

The controller may be configured or programmed to manage package positions after delivery on the discharge conveyor, and determine a position at which the package is delivered onto the discharge conveyor, based on recent package positions. In this system, by sequentially managing the package positions on the discharge conveyor and by changing the package delivery position, the packages can be sequentially delivered to package deliverable positions on the discharge conveyor while discharging the packages by the discharge conveyor, for example.

The controller may be configured or programmed to operate the discharge conveyor, so as to allow the package to be delivered onto the discharge conveyor while moving the circular conveyor and the discharge conveyor in synchronization with each other. In this system, the discharge conveyor is moved when the package is delivered to the discharge conveyor. Therefore, the number of the package deliverable positions increases on the discharge conveyor. As a result, the number of the packages that can be delivered onto the discharge conveyor in a predetermined time interval can be increased.

The controller may be configured or programmed to drive the discharge conveyor in a discharge direction, if the package is delivered to the package delivery position which is the most downstream of the discharge direction among the package delivery positions of the transferable section, and the packages are delivered to the package delivery positions at a predetermined ratio of all the package delivery positions in the transferable section. Further, the controller may be configured or programmed to stop the discharge conveyor so as to deliver the package from the circular conveyor to the discharge conveyor, after driving the discharge conveyor and before the positions on the discharge conveyor that were in the transferable section before the driving became completely outside of the transferable section. At this time, it may be possible to simultaneously discharge the package from the position on the discharge conveyor that is outside of the transferable section to another position.

The controller may be configured or programmed to determine whether or not a package deliverable position is on the discharge conveyor, and may be configured or programmed to control the circular conveyor to move the package in a loop without delivering the package if a package deliverable position is not on the discharge conveyor. Note that the determination whether or not there is a package deliverable position may be performed, for example, when the circular conveyor is conveying the package, or when the controller determines the package delivery position on the discharge conveyor based on the retrieval order in which the packages are retrieved from the discharge conveyor. In this system, when delivering the package to the discharge conveyor while moving the discharge conveyor, if the delivery cannot be performed, the circular conveyor moves the package in a loop. In this way, by enabling movement in a loop, a necessity of limiting the number of packages that the circular conveyor conveys or conveying order thereof is reduced or eliminated. As a result, a lot of packages can be loaded onto the circular conveyor and conveyed.

In a conveyance system according to a preferred embodiment of the present invention, it is possible to set a retrieval order properly regardless of an arrival order of packages to the conveyance system.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a plan view of a conveyance system of a first preferred embodiment of the present invention.

FIG. 2 is a schematic diagram of the conveyance system of the first preferred embodiment of the present invention.

FIG. 3 is a block diagram illustrating a control configuration of the conveyance system of the first preferred embodiment of the present invention.

FIG. 4 is a flowchart illustrating package conveyance control operation of a circular conveyor of the first preferred embodiment of the present invention.

FIG. 5 is a schematic diagram illustrating operations of the circular conveyor and a discharge conveyor of the first preferred embodiment of the present invention.

FIG. 6 is a schematic diagram illustrating operations of the circular conveyor and the discharge conveyor of the first preferred embodiment of the present invention.

FIG. 7 is a schematic diagram illustrating operations of the circular conveyor and the discharge conveyor of the first preferred embodiment of the present invention.

FIG. 8 is a schematic diagram illustrating operations of the circular conveyor and the discharge conveyor of the first preferred embodiment of the present invention.

FIG. 9 is a flowchart illustrating the package conveyance control operation of the circular conveyor of a second preferred embodiment of the present invention.

FIG. 10 is a schematic diagram illustrating operations of the circular conveyor and the discharge conveyor of the second preferred embodiment of the present invention.

FIG. 11 is a schematic diagram illustrating operations of the circular conveyor and the discharge conveyor of the second preferred embodiment of the present invention.

FIG. 12 is a schematic diagram illustrating operations of the circular conveyor and the discharge conveyor of the second preferred embodiment of the present invention.

FIG. 13 is a schematic diagram illustrating operations of the circular conveyor and the discharge conveyor of the second preferred embodiment of the present invention.

FIG. 14 is a flowchart illustrating the package conveyance control operation of the circular conveyor of a third preferred embodiment of the present invention.

FIG. 15 is a schematic diagram illustrating operations of the circular conveyor and the discharge conveyor of the third preferred embodiment of the present invention.

FIG. 16 is a schematic diagram illustrating operations of the circular conveyor and the discharge conveyor of the third preferred embodiment of the present invention.

FIG. 17 is a schematic diagram illustrating operations of the circular conveyor and the discharge conveyor of the third preferred embodiment of the present invention.

FIG. 18 is a schematic diagram illustrating operations of the circular conveyor and the discharge conveyor of the third preferred embodiment of the present invention.

FIG. 19 is a schematic diagram illustrating operations of the circular conveyor and the discharge conveyor of the third preferred embodiment of the present invention.

FIG. 20 is a schematic diagram illustrating operations of the circular conveyor and the discharge conveyor of the third preferred embodiment of the present invention.

### DETAILED DESCRIPTION OF THE PREFERRED EMBODIMENTS

### 1. First Preferred Embodiment

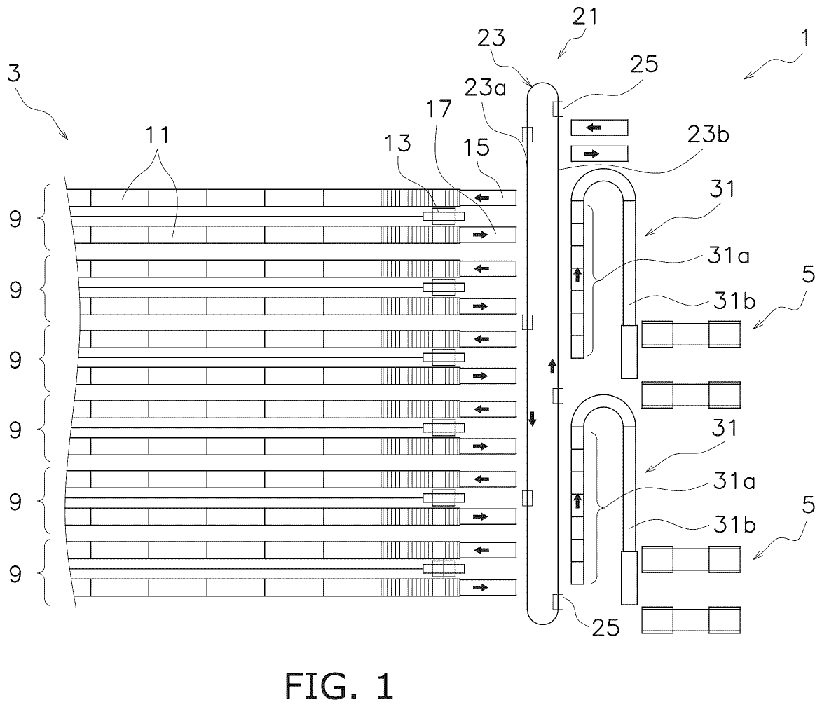

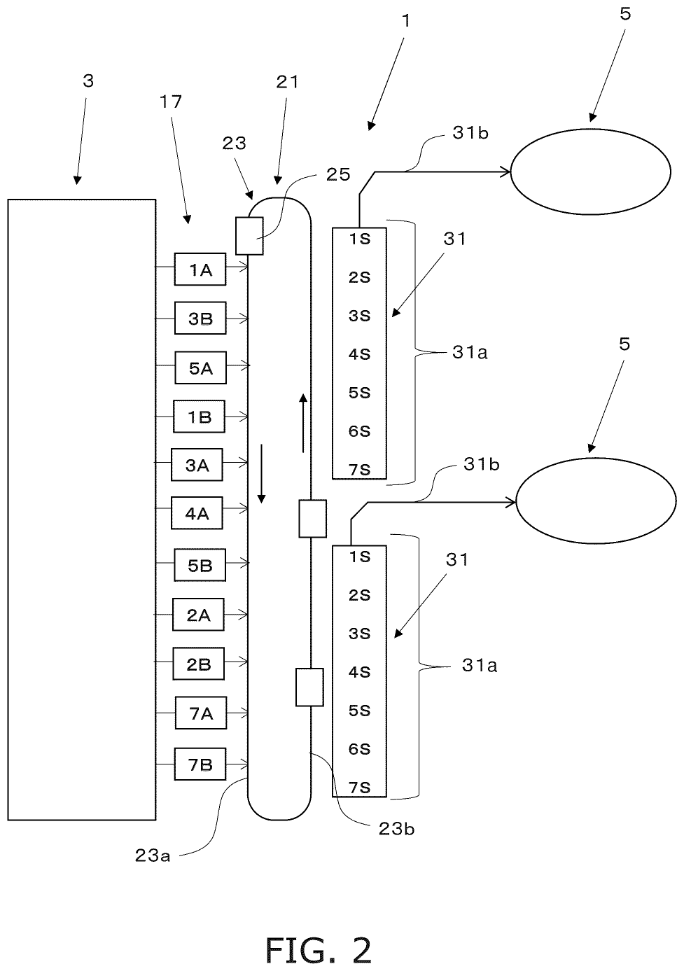

With reference to FIGS. 1 and 2, a conveyance system 1 of a first preferred embodiment is described. FIG. 1 is a plan view of the conveyance system of the first preferred embodiment. FIG. 2 is a schematic diagram of the conveyance system. The conveyance system 1 (an example of the conveyance system) is a package conveying equipment disposed between an automated warehouse 3 storing a lot of packages (e.g., cases) and a palletizing device 5 that palletizes packages.

As illustrated in FIG. 1, the automated warehouse 3 includes a plurality of automated warehouse units 9, each of which includes a pair of storage racks 11 each storing a lot of packages, and a stacker crane 13 that moves in the space between the storage racks 11. In each of the automated warehouse units 9, a storing conveyor 15 and a retrieving conveyor 17 for packages are disposed corresponding to the storage rack 11. The stacker crane 13 conveys packages between the storage rack 11 and the storing conveyor 15, and between the storage rack 11 and the retrieving conveyor 17.

The palletizing device 5 sequentially stacks the packages supplied from a discharge conveyor 31, for example, and sequentially palletizes the stacked packages on a pallet.

The conveyance system 1 includes a circular conveyor 21 (an example of the circular conveyor). The circular conveyor 21 includes a rail 23 (an example of the package conveyance path) that is disposed at a position corresponding to the storing conveyor 15 and the retrieving conveyor 17 and is formed in a loop shape (circular shape), and a plurality of conveying carts 25 that carry packages along the rail 23. The plurality of conveying carts are case conveying railed carts that are guided by the rail 23 to move in a predetermined direction shown by arrows (a constant direction) and carry packages. The rail 23 includes a first straight section 23a connected to the storing conveyor 15 and the retrieving conveyor 17 on the side of the automated warehouse 3, and a second straight section 23b on the opposite side to the first straight section 23a.

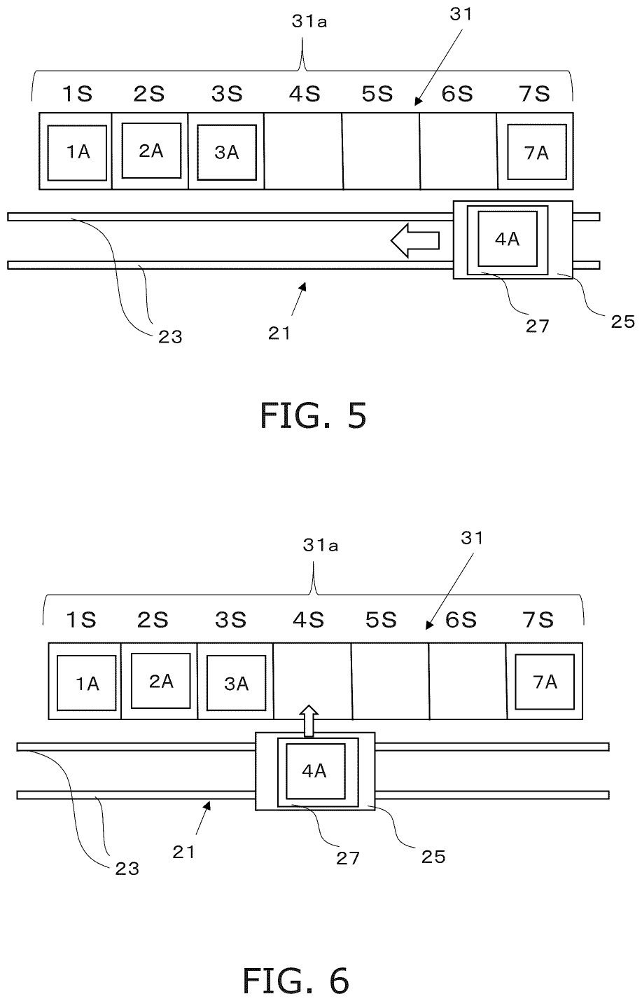

The conveying cart 25 is driven by a linear motor (not shown). Specifically, the conveying cart 25 includes a magnet array including a plurality of permanent magnets arranged. Further, a lot of armatures are disposed continuously or discretely along a track. Magnetic action from the armatures causes the magnet array to produce thrust in the traveling direction, and the conveying cart 25 is driven to travel along the rail 23. The conveying cart 25 includes a transfer conveyor 27 (FIG. 5). The transfer conveyor 27 is disposed on a top surface of a main body of the conveying cart 25, and is capable of transferring a package in a lateral direction perpendicular or substantially perpendicular to a conveying direction. The transfer conveyor 27 is a belt conveyor, a roller conveyor, or a chain conveyor, for example. Note that it may be possible to use not the conveyor but a rear hook arm or a pusher as a transfer device.

With the structure described above, when receiving a conveyance command, the conveying cart 25 travels to the retrieving conveyor 17, loads the package from the retrieving conveyor 17, travels to the discharge conveyor 31 (described later), and delivers the package to the discharge conveyor 31.

The conveyance system 1 includes the discharge conveyor 31 (an example of the discharge conveyor). The discharge conveyor 31 is a device to discharge the package discharged from the automated warehouse 3 to the palletizing device 5. The discharge conveyor 31 is disposed on the opposite side to the automated warehouse 3 with respect to the rail 23. In this preferred embodiment, two discharge conveyors 31 are disposed. The discharge conveyor 31 is a belt conveyor, for example. The discharge conveyor 31 includes a transferable section 31a. The transferable section 31a is a straight section parallel or substantially parallel to the second straight section 23b of the rail 23 of the circular conveyor 21. The discharge conveyor 31 includes a conveyance section 31b. The conveyance section 31b extends from the transferable section 31a to the palletizing device 5.

As illustrated in FIG. 2, the transferable section 31a of the discharge conveyor 31 includes a first region 1S, a second region 2S, a third region 3S, a fourth region 4S, a fifth region 5S, a sixth region 6S, and a seventh region 7S. Each region can carry one package, for example. For instance, when the discharge conveyor 31 is driven, the package transferred to the seventh region 7S moves on the seventh region 7S, the sixth region 6S, the fifth region 5S, the fourth region 4S, the third region 3S, the second region 2S, and the first region 1S in order. In this way, the packages placed on the first region 1S, the second region 2S, the third region 3S, the fourth region 4S, the fifth region 5S, the sixth region 6S, and the seventh region 7S, are respectively retrieved in order from the discharge conveyor 31.

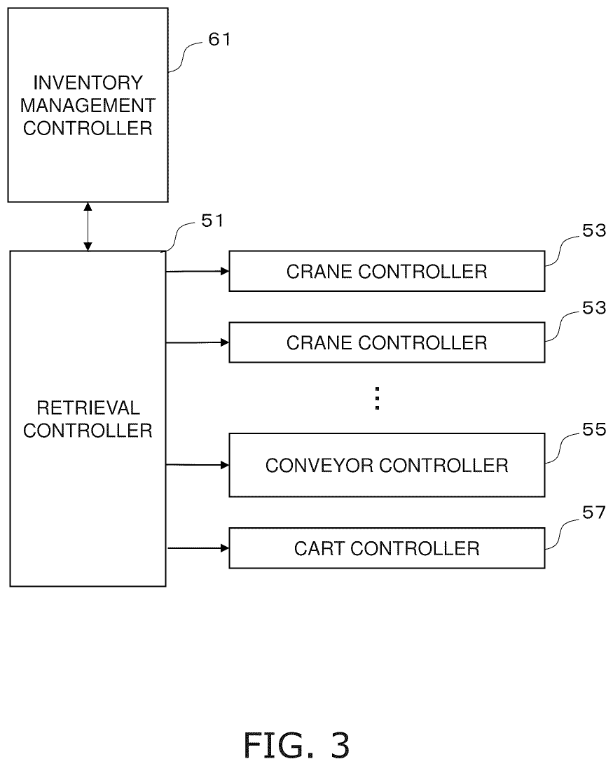

With reference to FIG. 3, control configuration of the conveyance system 1 is described. FIG. 3 is a block diagram illustrating control configuration of the conveyance system. The conveyance system 1 includes a retrieval controller 51. The retrieval controller 51 is a computer system including a processor (such as a CPU), a storage device (such as a ROM, a RAM, an HDD, and a SSD), and various interfaces (such as an A/D converter, a D/A converter, and a communication interface). The retrieval controller 51 executes a program stored in a storage unit (corresponding to a part or the whole of a storage region of the storage device), so as to perform various control operations.

The retrieval controller 51 may include a single processor, or may include a plurality of processors that are independent of each other for individual controls. A portion or an entirety of functions of individual elements of the retrieval controller 51 may be realized as a program executable by a computer system defining a control unit. Other than that, a portion of functions of individual elements of the retrieval controller 51 may be provided by or in a custom IC. The same is true for other controllers.

The retrieval controller 51 is connected to an inventory management controller 61. The inventory management controller 61 creates retrieval data as retrieval information to retrieve packages according to a predetermined retrieval schedule, and sends the retrieval data to the retrieval controller 51. The retrieval data is data that requests the discharge conveyor 31 to retrieve in a predetermined retrieval order, by selecting a plurality of packages as one retrieval group (retrieval unit) from packages stored in the storage racks 11 of the automated warehouse units 9. The inventory management controller 61 sequentially outputs retrieval instruction data in a predetermined retrieval work sequence set for the retrieval group of each retrieval data, and in the retrieval order instructed for each retrieval group. Here, the discharge conveyor 31 to which the packages of one retrieval group are released is predetermined.

The retrieval controller 51 is connected to a plurality of crane controllers 53. The crane controller 53 controls the stacker crane 13. Specifically, the crane controller 53 controls the stacker crane 13 to perform discharge work based on a command from the retrieval controller 51. The retrieval controller 51 is connected to a conveyor controller 55. The conveyor controller 55 controls the storing conveyor 15, the retrieving conveyor 17, and the discharge conveyor 31. Specifically, based on a command from the retrieval controller 51, the conveyor controller 55 controls the storing conveyor 15, the retrieving conveyor 17, and the discharge conveyor 31 to perform conveyance work. The retrieval controller 51 is connected to a cart controller 57. The cart controller 57 controls each conveying cart 25. Specifically, based on a command from the retrieval controller 51, the cart controller 57 controls each conveying cart 25 to perform conveyance work.

Although not illustrated, the retrieval controller 51 is connected to sensors to detect size, shape, and position of the package, sensors and switches to detect states of devices, and an information input device. More specifically, the retrieval controller 51 determines the position of the conveying cart 25, the traveling state thereof (presence or absence of traveling, speed, and acceleration or deceleration), loading state, and package information, using the various sensors. In addition, the retrieval controller 51 determines the driving state of the discharge conveyor 31 (presence or absence of driving, moving speed), presence or absence of package, position of the same, and package information, using the various sensors. Note that a portion or an entirety of the functions of the retrieval controller 51 described above may be performed by the cart controller 57.

The retrieval controller 51 sequentially receives the retrieval instruction data sequentially output from the inventory management controller 61. The retrieval controller 51 communicates data with the crane controllers 53, the conveyor controller 55, and the cart controller 57. Based on the sequentially received retrieval instruction data, the retrieval controller 51 first controls the stacker crane 13 via the crane controller 53, and allows the package instructed in each retrieval instruction data to be discharged by the retrieving conveyor 17.

In this preferred embodiment, the conveying cart 25 can randomly load the packages retrieved from the plurality of automated warehouse units 9. This is because there are a plurality of the discharge conveyors 31 to release the package, and the discharge conveyor 31 at which the package is to be released is predetermined, so it is not necessary to control the transfer order of the conveying carts 25. As a result, it is possible to reduce the number of times of stopping the stacker crane 13 due to that the package retrieved from the automated warehouse 3 is not loaded. Note that in a conventional method, the conveying cart 25 is required to load the packages belonging to one retrieval group in the order in which the retrieval instruction data instructing the package retrievals were entered.

Based on the sequentially received retrieval instruction data, the retrieval controller 51 first controls the stacker crane 13 via the crane controller 53 to discharge the package instructed by the retrieval instruction data onto the retrieving conveyor 17. At this time, the package is retrieved regardless of the package order assigned to the discharge conveyor 31. Therefore, the package instructed by the sequentially entered retrieval instruction data is discharged to each retrieving conveyor 17, without waiting for completion of discharge of the package instructed by the previously entered retrieval instruction data. For instance, as illustrated in FIG. 2, packages of two retrieval groups (retrieval group A and retrieval group B) are retrieved from the plurality of automated warehouse units 9 to the circular conveyor 21 without limiting the order.

Based on the sequentially entered retrieval instruction data, the retrieval controller 51 controls the retrieving conveyor 17 and the conveying cart 25 via the conveyor controller 55 and the cart controller 57, respectively, so that the conveying cart moves to a delivery position from the retrieving conveyor 17, and so that the package is transferred onto the conveying cart 25. Based on the sequentially received retrieval instruction data, the retrieval controller 51 controls the conveying cart 25 via the cart controller 57 so that the conveying cart 25 moves to a delivery position to the discharge conveyor 31.

When each conveying cart 25 moves to the delivery position to each discharge conveyor 31, the retrieval controller 51 controls the conveying cart 25 and the discharge conveyor 31 via the cart controller 57 and the conveyor controller 55, so as to transfer the package from the conveying cart 25 onto the discharge conveyor 31. Lastly, the retrieval controller 51 controls the discharge conveyor 31 via the conveyor controller 55 to convey the package to the target discharge conveyor 31.

In the control operation described above, the retrieval controller 51 determines the retrieval order in which the packages are retrieved from the discharge conveyor 31. Therefore, the retrieval controller 51 determines the package delivery position on the discharge conveyor 31 based on the retrieval order. For instance, if packages 1A to 7A belong to the retrieval group A, and the above-mentioned order is the retrieval order, regions 1S to 7S on the discharge conveyor 31 illustrated in FIG. 2 are the package delivery positions, respectively. In other words, the conveying cart 25 transfers the package to one of the regions 1S to 7S on the discharge conveyor 31 based on the package to be conveyed, so that the packages are in sequence in the retrieval order. In this way, the packages of the retrieval group instructed by the retrieval data are sequentially retrieved in the retrieval order instructed by the discharge conveyors 31.

In the structure and operation described above, the discharge conveyor 31 includes the transferable section 31a that is parallel or substantially parallel to the circular conveyor 21 and enables placement of a plurality of packages, and hence the discharge conveyor 31 includes a plurality of package deliverable positions (the regions 1S to 7S). Therefore, by changing a package delivery planned position at which the package is to be delivered from the circular conveyor 21 for each package, the package arrangement on the discharge conveyor 31 can be set as requested. In other words, for example, it is not necessary to adjust the retrieval order from the automated warehouse 3 to the circular conveyor 21.

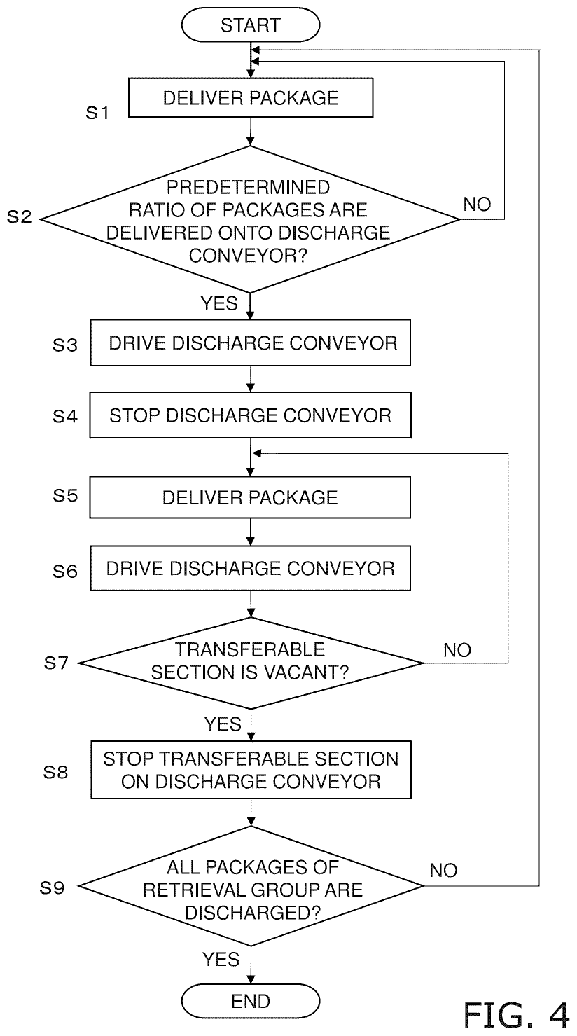

With reference to FIGS. 4 to 10, a conveyance control operation of the circular conveyor 21 is described below in detail. FIG. 4 is a flowchart illustrating package conveyance control operation by the circular conveyor. FIGS. 5 to 10 are schematic diagrams illustrating operations of the circular conveyor and the discharge conveyor.

The control flowchart described below is merely an example, and each step can be eliminated or exchanged as necessary. In addition, a plurality of steps may be simultaneously executed, or a portion or an entirety thereof may be executed in an overlapping manner. Furthermore, each block in the control flowchart is not necessarily a single control operation but can be replaced by a plurality of control operations expressed in a plurality of blocks.

Note that action of each device is a result of an instruction from the retrieval controller 51 to the device, which is expressed by each step of software application.

In Step S1, delivery of a package is performed. Specifically, the conveying cart 25 moves to a predetermined position and delivers the package. At this time, the discharge conveyor 31 is in a stopped state. As an example, in FIG. 5, the first package 1A, the second package 2A, the third package 3A, and the seventh package 7A are delivered to predetermined positions on the discharge conveyor 31, respectively. In FIG. 6, the conveying cart 25 carrying the fourth package 4A stops in front of the planned position at which the fourth package 4A is to be placed (the fourth region 4S in FIG. 6), among the package deliverable positions on the discharge conveyor 31, and delivers the fourth package 4A.

In Step S2, it is determined whether or not the packages delivered onto the discharge conveyor 31 have reached a predetermined ratio. If Yes, the process proceeds to Step S3. The predetermined ratio is about 70% to about 80% or more of the regions of the transferable section 31a, for example. In addition, the determination described above includes whether or not the package is delivered in the first region 1S. Even if the predetermined ratio has been reached, if the package to be delivered in the first region 1S is not delivered yet, the process does not proceed to Step S3. It is because when the discharge conveyor 31 is driven in Step S3 as described later, the package to be delivered in the first region 1S becomes unable to be delivered. In addition, if No in Step S2, the process returns to Step S1.

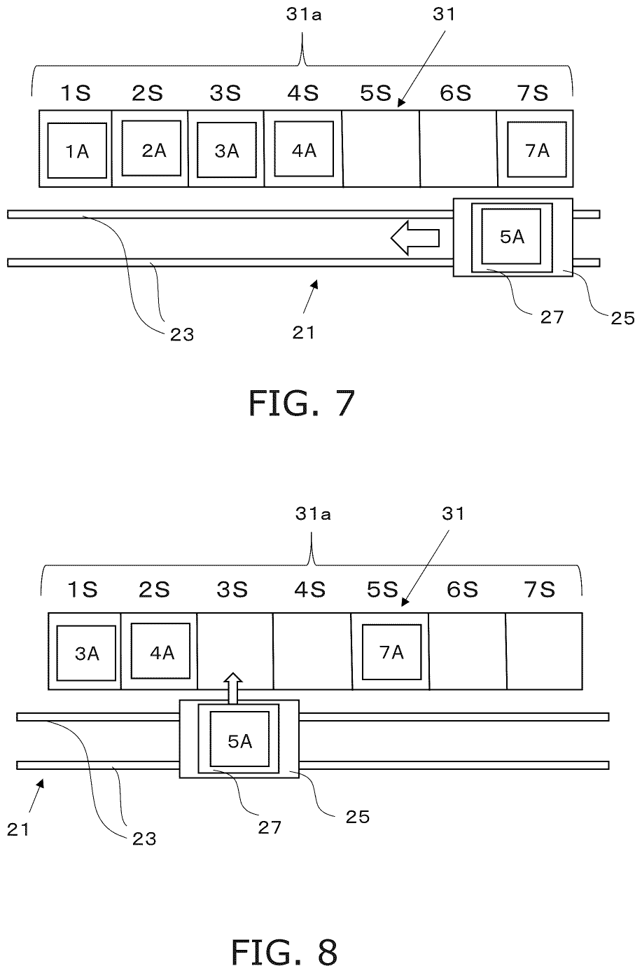

In Step S3, the discharge conveyor 31 is driven. As an example, in FIG. 7, the discharge conveyor 31 is driven in the state where the first package 1A, the second package 2A, the third package 3A, the fourth package 4A, and the seventh package 7A are placed on the transferable section 31a.

In Step S4, the discharge conveyor 31 is stopped. A movement amount of the discharge conveyor in Step S3 is not particularly limited. However, the movement amount is set so that at least the package that will be transferred from now on can be transferred in such a manner to maintain the retrieval order.

In Step S5, the conveying cart 25 stops in front of the delivery planned position among the package deliverable positions of the discharge conveyor 31, and delivers the package. As an example, in FIG. 8, the conveying cart 25 carrying the fifth package 5A moves to front of the conveyor position at which the fifth package 5A is to be delivered (the third region 3S in FIG. 8), and delivers the fifth package 5A.

In the control operation described above, the retrieval controller 51 manages package positions after delivery on the discharge conveyor 31. Specifically, the retrieval controller 51 determines the package positions after delivery on the discharge conveyor 31 every predetermined time interval, for example. The package positions described above is recognized when the retrieval controller 51 performs tracking with an encoder (not shown) provided to the discharge conveyor 31, for example. Further, the retrieval controller 51 determines the position at which the package is delivered onto the discharge conveyor 31, based on the latest package positions. Therefore, it sequentially manages the package positions on the discharge conveyor 31, and changes the package delivery position, and thus can sequentially deliver the packages to the package deliverable positions on the discharge conveyor 31, while the discharge conveyor 31 discharges the packages.

In Step S6, the discharge conveyor 31 is driven. In Step S7, it is determined whether or not all the packages have disappeared from the transferable section 31a. If Yes, the process proceeds to Step S8. If No, the process returns to Step S5.

In Step S8, movement of the transferable section 31a on the discharge conveyor 31 is stopped. Note that the conveyance section 31b of the discharge conveyor 31 continues to operate until the package reaches the palletizing device 5.

In Step S9, it is determined whether or not all the packages of the retrieval group are discharged. If Yes, the process finishes. If No, the process returns to Step S1.

### 2. Second Preferred Embodiment

In the first preferred embodiment, the discharge conveyor 31 starts to move when the predetermined ratio of the packages are transferred. However, as another preferred embodiment, it may be possible to prevent the discharge conveyor 31 from moving until all the packages are transferred.

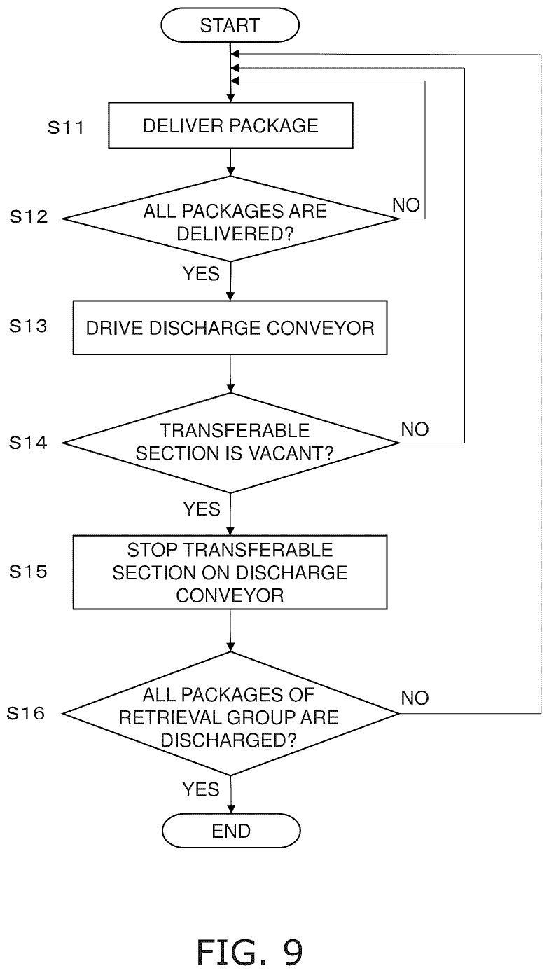

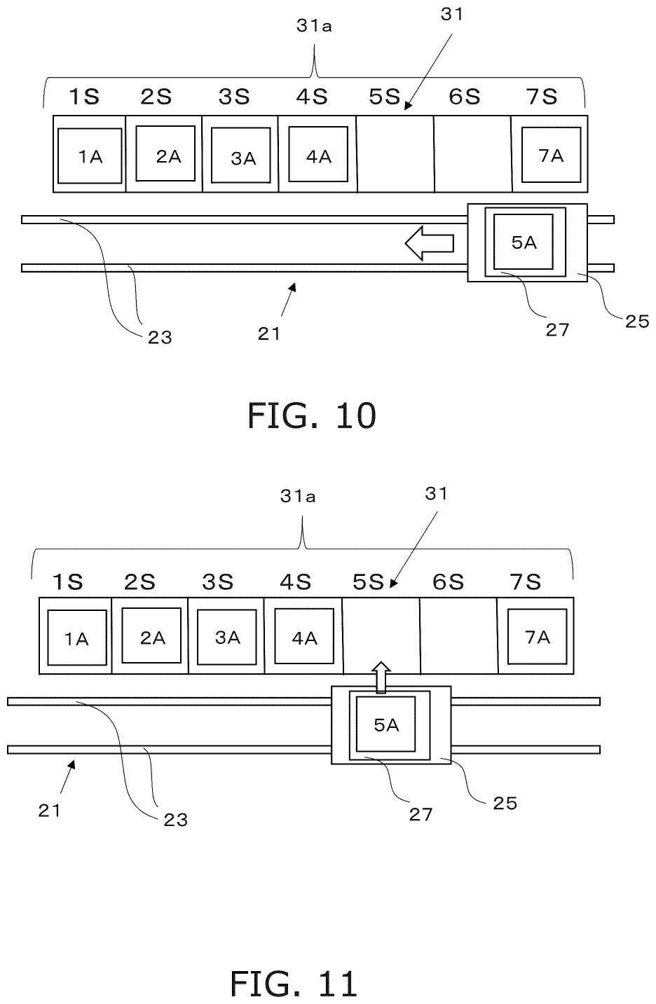

With reference to FIGS. 9 to 13, such a preferred embodiment is described below as a second preferred embodiment. FIG. 9 is a flowchart illustrating the package conveyance control operation of the circular conveyor of the second preferred embodiment. FIGS. 10 to 13 are schematic diagrams illustrating operations of the circular conveyor and the discharge conveyor. Note that the basic structure and the basic operation of the second preferred embodiment are the same as those of the first preferred embodiment.

In Step S11, delivery of the package is performed. Specifically, the conveying cart 25 moves to a predetermined position and delivers the package. At this time, the discharge conveyor 31 is in the stopped state. As an example, in FIG. 10, the first package 1A, the second package 2A, the third package 3A, the fourth package 4A, and the seventh package 7A are respectively delivered at predetermined positions on the transferable section 31a of the discharge conveyor 31. In FIG. 11, the conveying cart carrying the fifth package 5A stops in front of the planned position at which the fifth package 5A is to be placed (the fifth region 5S in FIG. 11), among the package deliverable positions on the discharge conveyor 31, and delivers the fifth package 5A. In Step S12, it is determined whether or not all the packages are delivered to the discharge conveyor 31. If Yes, the process proceeds to Step S13. If No, the process returns to Step S11.

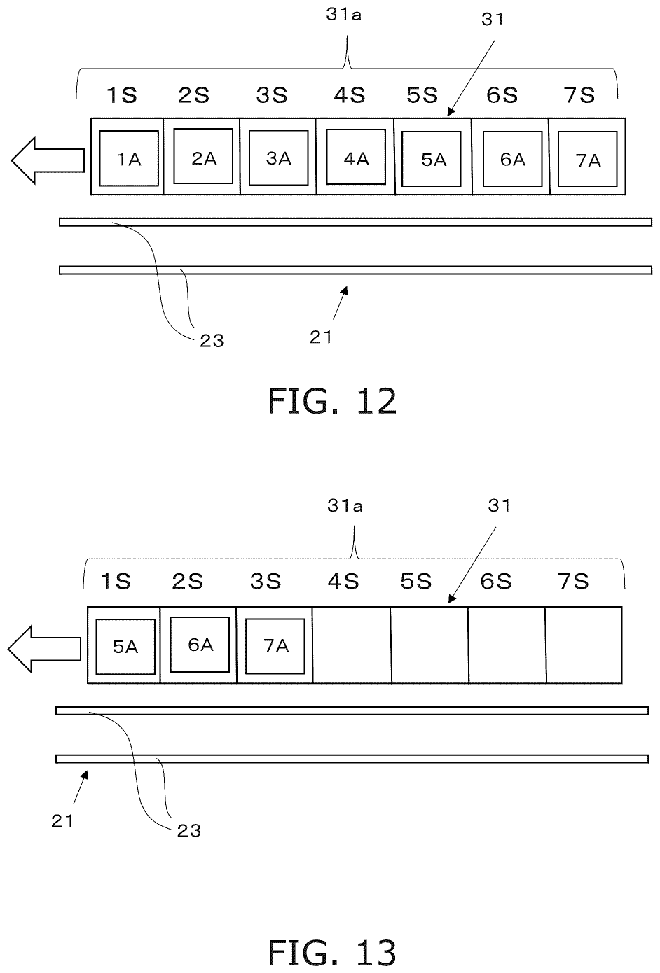

In Step S13, the discharge conveyor 31 is driven. As an example, in FIG. 12, the first package 1A, the second package 2A, the third package 3A, the fourth package 4A, the fifth package 5A, the sixth package 6A, and the seventh package 7A are placed on the transferable section 31a, and next the discharge conveyor 31 is driven. FIG. 13 illustrates a state of the transferable section 31a that is moving after that. In Step S14, it is determined whether or not the placed packages have disappeared from the transferable section 31a. If Yes, the process proceeds to Step S15. If No, the process returns to Step S11.

In Step S15, movement of the transferable section 31a of the discharge conveyor 31 is stopped. Note that the conveyance section 31b of the discharge conveyor 31 continues to operate until the package reaches the palletizing device 5. In Step S16, it is determined whether or not all the packages of the retrieval group are discharged. If Yes, the process finishes. If No, the process returns to Step S11.

### 3. Third Preferred Embodiment

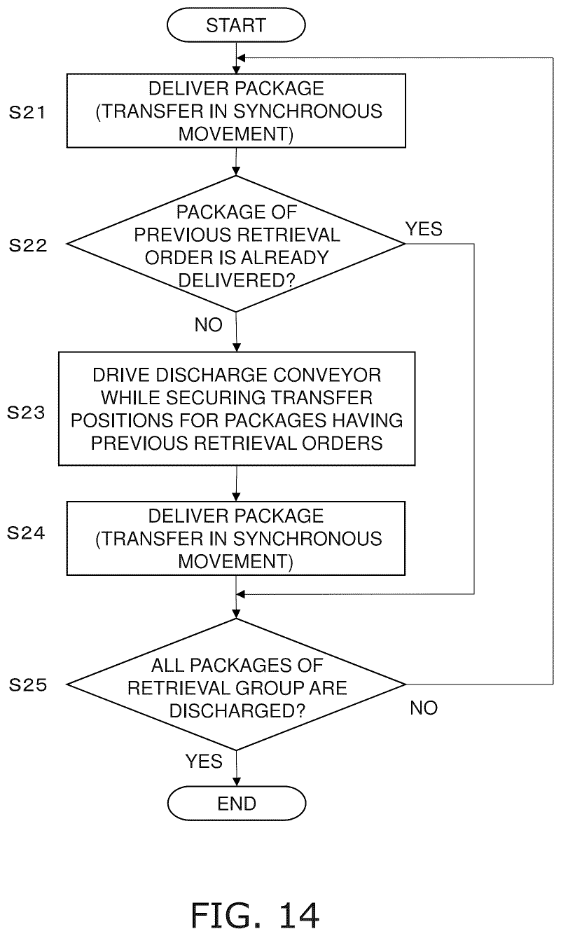

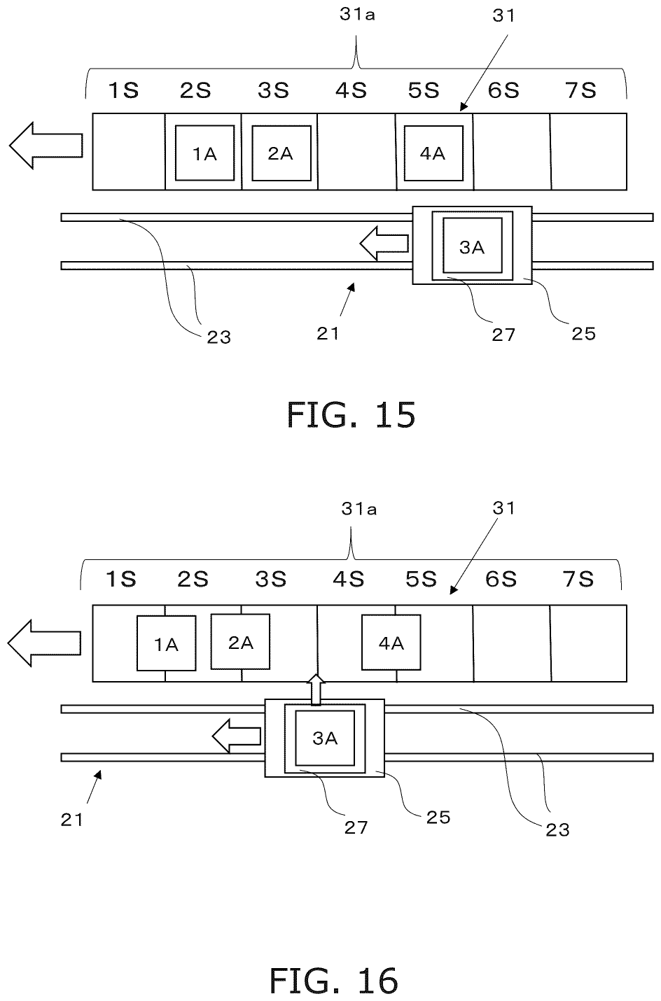

In the first preferred embodiment and in the second preferred embodiment, movement of the circular conveyor 21 is stopped when circular conveyor 21 delivers the package to the discharge conveyor 31. As another preferred embodiment, it may be possible that the circular conveyor 21 continues to move when the package is delivered. With reference to FIGS. 14 to 20, such a preferred embodiment is described below as a third preferred embodiment. FIG. 14 is a flowchart illustrating the package conveyance control operation of the circular conveyor of the third preferred embodiment. FIGS. 15 to 20 are schematic diagrams illustrating operations of the circular conveyor and the discharge conveyor. Note that the basic structure and the basic operation of the third preferred embodiment are the same as those of the first preferred embodiment.

In this preferred embodiment, the conveying carts 25 are always traveling in a loop. In Step S21, the package is delivered. Specifically, the discharge conveyor 31 is driven so that the position at which the package is transferred moves, and next, the conveying cart 25 moves at the same speed as the discharge conveyor 31, so as to deliver the package at the position. As an example, in FIG. 15, the discharge conveyor 31 is driven in the state where the first package 1A, the second package 2A, and the fourth package 4A are placed on the transferable section 31a. Next, in FIG. 16, the conveying cart 25 catches up to the package position between the second package 2A and the fourth package 4A by acceleration, and delivers the third package 3A.

In Step S22, it is determined whether or not the package, which has the retrieval order previous to the package that is already transferred among the packages in the retrieval group, is already delivered. If Yes (that is already delivered), the process skips Step S23 and Step S24, and proceeds to Step S25. If No (that is not delivered yet), the process proceeds to Step S23.

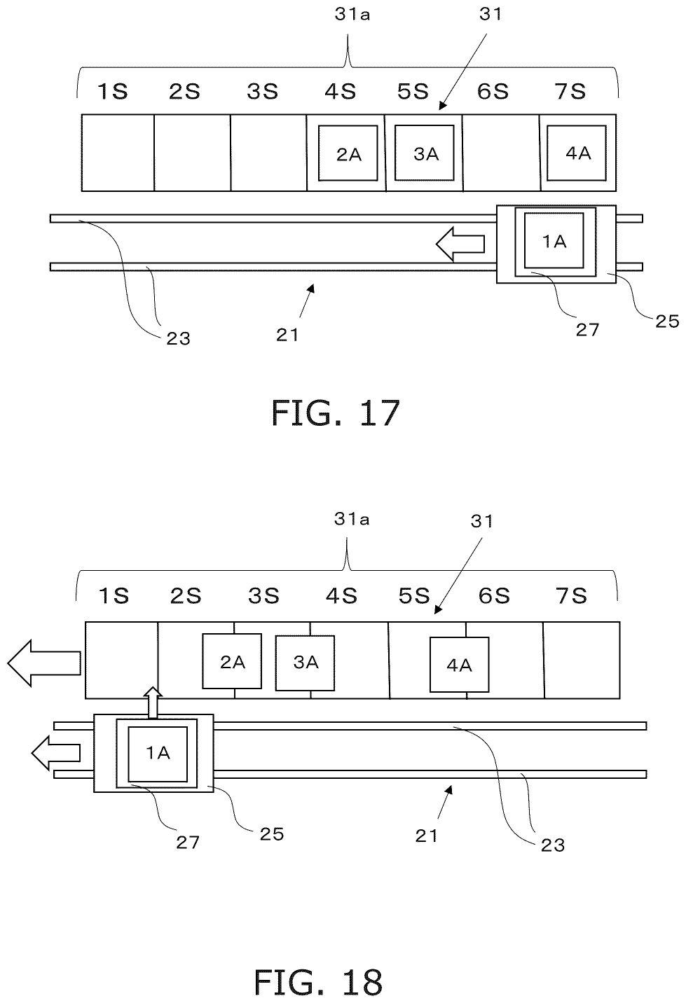

In Step S23, the discharge conveyor 31 is driven so that the first region 1S, the second region 2S, and the third region 3S, which are transfer positions for the packages having the previous retrieval orders, become vacant space, for example. However, if the conveying cart 25 cannot catch up and the transfer position for the package having the previous retrieval order disappears, it may be possible to stop temporarily. As an example, in FIG. 17, the first region 1S, the second region 2S, the third region 3S and the sixth region 6S are vacant spaces, and the second package 2A is placed on the fourth region 4S, the third package 3A is placed on the fifth region 5S, and the fourth package 4A is placed on the seventh region 7S.

In Step S24, the package to be retrieved prior to the package that is already delivered to the transferable section 31a (the package 1A in FIG. 17) is transferred. Specifically, the discharge conveyor 31 is driven, and the conveying cart 25 transfers the package while performing synchronous travel. As an example, in FIG. 18, the conveying cart 25 catches up to the downstream side position of the second package 2A in the conveying direction, and transfers the first package 1A at the position. In Step S25, it is determined whether or not all the packages of the retrieval group are discharged. If Yes, the process finishes. If No, the process returns to Step S21.

In the control operation described above, the retrieval controller 51 manages the package positions after delivery on the discharge conveyor 31. Specifically, the retrieval controller 51 determines the package positions after delivery on the discharge conveyor 31 every predetermined time interval, for example. Further, the retrieval controller 51 determines the position at which the package is delivered onto the discharge conveyor 31, based on the latest package positions. Therefore, the retrieval controller 51 sequentially manages the package positions on the discharge conveyor 31, and changes the package delivery position, and thus can sequentially deliver the packages to the package deliverable positions on the discharge conveyor 31, while the discharge conveyor 31 discharges the packages, for example.

In the control operation described above, the retrieval controller 51 controls the discharge conveyor 31 to move, and controls the circular conveyor 21 to move in synchronization with the discharge conveyor 31, so as to deliver the package to the discharge conveyor 31. Specifically, the retrieval controller 51 controls each of the conveying carts 25 to travel at a travel speed synchronizing with a conveyance speed of the discharge conveyor 31 in the transferable section 31a, and in this state delivers the package via the transfer conveyor 27. In this way, when package is delivered onto the discharge conveyor 31, the discharge conveyor 31 is moved, and hence the package deliverable positions increase on the discharge conveyor 31. As a result, the number of the packages that can be delivered onto the discharge conveyor 31 in a predetermined time interval can be increased.

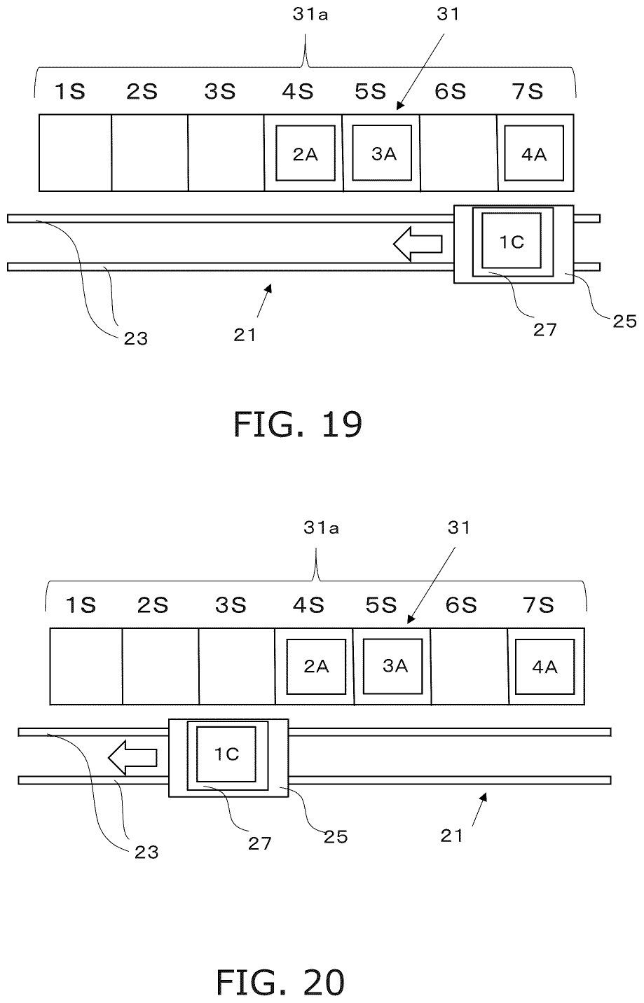

In Step S21 and Step S24 described above, the conveying cart 25 basically catches up to the package deliverable position of the discharge conveyor 31 and moves in the same speed to deliver the package. However, there may be no package deliverable position on the discharge conveyor 31. Therefore, the retrieval controller 51 determines whether or not there is a package deliverable position on the discharge conveyor 31. If there is no package deliverable position, it may be possible to allow the circular conveyor 21 to move the package in a loop without delivering the package from the circular conveyor 21. As an example, in FIG. 19, the packages of the retrieval group A are placed on the transferable section 31a, and a first package 1C of a retrieval group C is conveyed there. In this case, there is no position at which the first package 1C can be delivered. Therefore, as illustrated in FIG. 20, the circular conveyor 21 moves the first package 1C in a loop. In this way, by enabling to move in a loop, the necessity of limiting the number of packages that the circular conveyor 21 conveys or conveying order thereof is reduced or eliminated. As a result, a lot of packages can be loaded onto the circular conveyor 21 and conveyed. Note that there is a case where it is predetermined that the package is moved in a loop. For instance, if the number of the packages of the retrieval group is larger than the number of packages that can be placed on the transferable section 31a, the retrieval controller 51 determines the delivery position assuming that the package is moved in a loop, when determining the delivery position on the transferable section 31a based on the package retrieval order.

It is sufficient that the conveying cart 25 and the discharge conveyor 31 move in the same speed when the transferring operation is performed, and specific control for that is not particularly limited. As a variation, the conveying cart 25 may travel at a speed higher than that of the discharge conveyor 31 so as to catch up to the conveyor position at which the package is to be delivered, and after that may decelerate to the same speed as the discharge conveyor 31 so as to deliver the package while moving. As another variation, it may be possible to drive the discharge conveyor 31 at low speed so that the conveying cart 25 can catch up to the conveyor position at which the package is to be delivered, and accelerate the discharge conveyor 31 to the same speed as the conveying cart 25 at the transfer timing.

The first to third preferred embodiments have the common structures and functions as described below. The conveyance system (e.g., the conveyance system 1) includes the circular conveyor, the discharge conveyor, and the controller. The circular conveyor (e.g., the circular conveyor 21) includes the circular package conveyance path (e.g., the rail 23) to convey the package, and is capable of delivering the package. The discharge conveyor (e.g., the discharge conveyor 31) includes the transferable section (e.g., the transferable section 31a), parallel or substantially parallel to the package conveyance path of the circular conveyor, so as to enable the plurality of packages to be placed thereon. The controller (e.g., the retrieval controller) is configured or programmed to determine the retrieval order in which the packages are retrieved from the discharge conveyor, and to determine the package delivery position on the discharge conveyor based on the retrieval order. In this system, the package is delivered from the circular conveyor to the discharge conveyor. The discharge conveyor includes the transferable section parallel or substantially parallel to the package conveyance path of the circular conveyor, so as to enable the plurality of packages to be placed thereon, and hence the discharge conveyor includes the plurality of package deliverable positions. Therefore, by changing the package delivery planned position at which the package is delivered from the circular conveyor, for each package, the package arrangement on the discharge conveyor can be set as requested (e.g., FIG. 6). In other words, it is not necessary to adjust the retrieval order from the automated warehouse to the circular conveyor.

### 5. Other Preferred Embodiments

Although the preferred embodiments of the present invention are described above, the present invention is not limited to the preferred embodiments described above, and can be variously modified within the scope of the present invention without deviating from the spirit thereof. In particular, the plurality of preferred embodiments and variations described in this specification can be arbitrarily combined as necessary.

The number of discharge conveyors is not limited. The number of the packages that can be placed on the discharge conveyor is not limited. A discharge destination of the discharge conveyor is not limited to the palletizing device. A type of the discharge conveyor is not limited. The discharge conveyor may be a sorter that moves at a constant speed. For instance, the sorter is a linear sorter or a cross belt sorter. In the transferable section, if the number of packages of the retrieval group is small, the first region 1S may not be used. In this case, for example, three packages are placed on the regions 2S to 4S.

The number of the conveying carts is not limited. The conveying cart may be equipped with a battery and an electric motor. The circular conveyor may be a combination of a circular track and pallet conveying railed carts. The circular conveyor may be a cross sorter. The circular conveyor may be an AGV system without a rail.

Preferred embodiments of the present invention can be widely applied to conveyance systems each including a circular conveyor and a discharge conveyor.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-5. (canceled)

6. A conveyance system comprising:
a circular conveyor including a circular package conveyance path to convey packages, and being capable of delivering the packages;
a discharge conveyor including a transferable section parallel or substantially parallel to the package conveyance path of the circular conveyor, so as to enable a plurality of packages to be placed thereon; and
a controller configured or programmed to determine a retrieval order in which the packages are retrieved from the discharge conveyor, and to control a package delivery position from the circular conveyor to the discharge conveyor, based on the retrieval order.

7. The conveyance system according to claim 6, wherein the controller is configured or programmed to manage package positions after delivery onto the discharge conveyor, and control a position at which the package is delivered onto the discharge conveyor, based on recent package positions.

8. The conveyance system according to claim 7, wherein the controller is configured or programmed to drive the discharge conveyor in a discharge direction, if the package is delivered to the package delivery position which is most downstream in the discharge direction among the package delivery positions of the transferable section, and the packages are delivered to the package delivery positions at a predetermined ratio of all the package delivery positions in the transferable section.

9. The conveyance system according to claim 7, wherein the controller is configured or programmed to operate the discharge conveyor, and allow the package to be delivered onto the discharge conveyor while moving the circular conveyor and the discharge conveyor in synchronization with each other.

10. The conveyance system according to claim 9, wherein the controller is configured or programmed to determine whether or not a package deliverable position is on the discharge conveyor, and if a package deliverable position is not on the discharge conveyor, the controller is configured or programmed to control the circular conveyor to move the package in a loop without delivering the package.
